(19) United States
(12) Patent Application Publication
(10) Pub. No.: US 2026/0276538 A1
(43) Pub. Date: Sep. 17, 2026

(54) RESIN INSPECTION METHOD AND RESIN INSPECTION APPARATUS

(71) Applicant: SEIKO EPSON CORPORATION, TOKYO (JP)

(72) Inventor: Masayasu FUKUOKA, SHIOJIRI-SHI (JP)

(21) Appl. No.: 19/562,941

(22) Filed: Mar. 11, 2026

(30) Foreign Application Priority Data
Mar. 11, 2025 (JP) 2025-038087

(51) Int. Cl. G01N 21/3563; B29C 45/76; G01N 21/31; G01N 21/359

(52) U.S. Cl. CPC G01N 21/3563; B29C 45/76; G01N 21/314; B29C 2945/76287; G01N 2021/3196; G01N 21/359

(57) ABSTRACT

A resin inspection method include acquiring a spectral characteristic value at a light absorption wavelength of the inspection target, and estimating a degree of deterioration of the recycled material contained in the inspection target, estimating the degree of deterioration include calculating a first regression line corresponding to a content of the recycled material of the inspection target and representing a correlation between the spectral characteristic value and the degree of deterioration based on a correlation database containing multiple pieces of correlation data in each of which the spectral characteristic value, the degree of deterioration of the recycled material, and the content of the recycled material in the resin material are associated with each other and in which at least the degrees of deterioration differ from each other, and calculating the degree of deterioration corresponding to the spectral characteristic value of the inspection target based on the first regression line.

The present application is based on, and claims priority from JP Application Serial Number 2025-038087, filed Mar. 11, 2025, the disclosure of which is hereby incorporated by reference herein in its entirety.

### BACKGROUND

### 1. Technical Field

The present disclosure relates to a resin inspection method and a resin inspection apparatus.

### 2. Related Art

There is a known inspection apparatus that optically inspects the degree of deterioration of a resin material. For example, the apparatus described in JP-A-2015-189211 includes a light irradiator that irradiates a resin material with light, an optical intensity detector that receives light having passed through the resin material, and a determination portion that determines whether the degree of deterioration of the resin material due to heating during injection molding is acceptable based on a value detected by the optical intensity detector.

JP-A-2015-189211 is an example of the related art.

In recent years, a resin material containing a recycled material having undergone recycling has been used as a resin material for resin molding. Since the degree of deterioration of the recycled material changes in accordance with the number of times of the recycling performed on the recycled material and affects the quality of a molded product, an approach of determining the degree of deterioration of the recycled material is desired. The result of the optical inspection of the resin material is, however, affected not only by the degree of deterioration but also by the content of the recycled material in the resin material. It is therefore difficult for the detection apparatus described in JP-A-2015-189211 to accurately determine the degree of deterioration of the recycled material contained in the resin material.

### SUMMARY

A resin inspection method according to an aspect of the present disclosure is a resin inspection method for inspecting a resin material containing a recycled material or a molded product made of the resin material as an inspection target, the method including: a spectral characteristic value calculation step of acquiring a spectral characteristic value at a light absorption wavelength of the inspection target; and a deterioration degree estimation step of estimating a degree of deterioration of the recycled material contained in the inspection target based on the spectral characteristic value of the inspection target, the deterioration degree estimation step including calculating a first regression line corresponding to a content of the recycled material of the inspection target and representing a correlation between the spectral characteristic value and the degree of deterioration based on a correlation database containing multiple pieces of correlation data in each of which the spectral characteristic value, the degree of deterioration of the recycled material, and the content of the recycled material in the resin material are associated with each other and in which at least the degrees of deterioration differ from each other, and calculating the degree of deterioration corresponding to the spectral characteristic value of the inspection target based on the first regression line.

A resin inspection apparatus according to another aspect of the present disclosure is an apparatus configured to inspect a resin material containing a recycled material or a molded product made of the resin material as an inspection target, the resin inspection apparatus including: a spectral analyzer configured to acquire a spectral characteristic value at a light absorption wavelength of the inspection target; a storage configured to store a correlation database containing multiple pieces of correlation data in each of which the spectral characteristic value, a degree of deterioration of the recycled material, and a content of the recycled material of the resin material are associated with each other and in which at least the degrees of deterioration differ from each other; and a deterioration degree estimator configured to calculate a first regression line corresponding to the content of the recycled material of the inspection target and representing a correlation between the spectral characteristic value and the degree of deterioration, based on the correlation database, and calculate the degree of deterioration corresponding to the spectral characteristic value of the inspection target based on the first regression line.

### BRIEF DESCRIPTION OF THE DRAWINGS

FIG. 1 is a diagrammatic view showing a schematic configuration of a resin inspection apparatus according to the present embodiment.

FIG. 2 is a block diagram showing the schematic configuration of the resin inspection apparatus according to the present embodiment.

FIG. 3 shows optical spectra of multiple resin members (virgin material and recycled material) having different degrees of deterioration.

FIG. 4 is a flowchart for describing a resin inspection method according to the present embodiment.

FIG. 5 is a graph representing the correlation between the degree of deterioration of the recycled material and a spectral characteristic value.

FIG. 6 is a graph representing the correlation between the degree of deterioration of the recycled material and a mechanical characteristic value of the resin material for a recycled material content of 100%.

FIG. 7 is a graph corresponding to the degree of deterioration of an inspection target and representing the correlation between the recycled material content rate and the mechanical characteristic value.

FIG. 8 shows graphs illustrating the correlation between the degree of deterioration of the recycled material and the spectral characteristic value for the recycled material content being 100% and 30%.

FIG. 9 is a graph showing the correlation between the spectral characteristic value and the mechanical characteristic value.

### DESCRIPTION OF EMBODIMENTS

An embodiment of the present disclosure will be described below.

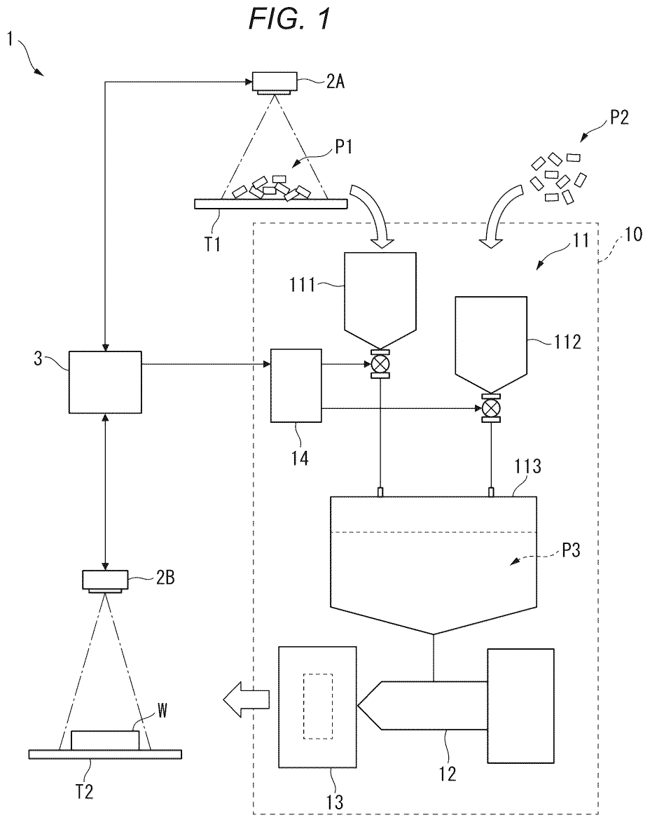

A resin inspection apparatus 1 according to the present embodiment can inspect a first resin material P1 loaded into an injection molding machine 10 and a molded product W molded in an injection molding process by the injection molding machine 10, as shown in FIG. 1. The resin inspection apparatus 1 according to the present embodiment can further manage the injection molding machine 10 based on the results of the inspection.

The injection molding machine 10 in the present embodiment performs injection molding of the molded product W made of a mixed resin material P3, which is a mixture of the first resin material P1 and a second resin material P2 mixed at any ratio. The first resin material P1 and the second resin material P2 each have, for example, a pellet shape.

In the present embodiment, the first resin material P1 is a recycled resin material (hereinafter referred to as recycled material), and the second resin material P2 is a new resin material (hereinafter referred to as virgin material). The recycled material is a resin material having undergone recycling, and the virgin material is a resin material having undergone no recycling, that is, an unused resin material.

Note that the first resin material P1 and the second resin material P2 may both be a resin material of the same type or may be resin materials of different types. The first resin material P1 and the second resin material P2 may each be a mixed resin that is a mixture of resins of multiple types. The type of each of the resins is not limited to a specific resin, and examples thereof may include an ABS resin, a polycarbonate resin, a polypropylene resin, and a talc resin.

For example, the first resin material P1 may be a recycled ABS resin material, and the second resin material P2 may be a virgin ABS material. Instead, the first resin material P1 may be a recycled ABS resin material, and the second resin material P2 may be a virgin material that is a mixture of ABS resin and polycarbonate resin.

### Configuration of Injection Molding Machine 10

The configuration of the injection molding machine 10 will first be briefly described. The injection molding machine 10 includes a resin loader 11, an injector 12, a molding portion 13, an injection controller 14, and the like.

The resin loader 11 includes a first loader 111, into which the first resin material P1 is loaded, a second loader 112, into which the second resin material P2 is loaded, and a mixer 113, which mixes the first resin material P1 and the second resin material P2 supplied from the first loader 111 and the second loader 112 and loads the mixed resin material P3 into the injector 12. The first loader 111 and the second loader 112 are each configured to be capable of adjusting the amount of the material to be supplied to the mixer 113, so that the proportion of the first resin material P1 in the mixed resin material P3 can be adjusted.

Note that the proportion of the first resin material P1 in the mixed resin material P3 corresponds to the content of the recycled material in the molded product W, and is expressed, for example, by weight percent. An inspection table T1 may be installed, as an inspection environment where the first resin material P1 is inspected, upstream of the first loader 111 in the process stream.

Each of the injector 12 and the molding portion 13 does not have a specific configuration, and may have the same configuration in related art. For example, the injector 12 includes a cylinder through which the resin material loaded from the mixer 113 is transferred, a heater that heats the resin material in the cylinder, a screw that feeds the resin material in the cylinder toward the molding portion 13, and a driver that drives the screw. The resin material loaded into the injector 12 is melted in the process of transferring the resin material through the cylinder, and the melted resin material is injected into the molding portion 13.

The molding portion 13 includes a die filled with the resin material injected from the injector 12, and a die clamper that clamps and opens the die. The mixed resin material P3 with which the die is filled is molded into the molded product W, which is taken out of the die. The molded product W is sent by any mechanism such as a conveyance robot to an inspection step carried out by the resin inspection apparatus 1. An inspection table T2 may be installed, as an inspection environment where the molded product W is inspected, downstream of the molding portion 13 in the process stream.

The injection controller 14 controls the operation of each portion of the injection molding machine 10. For example, the injection controller 14 sets the amounts of the first resin material P1 and the second resin material P2 to be supplied, the amount of the mixed resin material P3 to be loaded, the heating temperature, the rotation speed of the screw, the injection pressure, and the like in accordance with the conditions under which the molded product W is molded. Note that the injection controller 14 in the present embodiment can set the proportion of the first resin material P1 in the mixed resin material P3 (that is, content of recycled material in molded product W) in accordance with inspection results input from the resin inspection apparatus 1.

### Configuration of Resin Inspection Apparatus 1

The resin inspection apparatus 1 according to the present embodiment performs inspection on the first resin material P1 loaded into the injection molding machine 10 or the molded product W molded by the injection molding machine 10 as an inspection target. The resin inspection apparatus 1 includes a spectral measurement portion 2A, which acquires spectral information on the first resin material P1, a spectral measurement portion 2B, which acquires spectral information on the molded product W, and an inspection processor 3, which analyzes the spectral information acquired by any one of the spectral measurement portions 2A and 2B.

The spectral measurement portions 2A and 2B perform spectral measurement on the inspection target to acquire spectral information at multiple wavelengths in a predetermined wavelength region (near-infrared region, for example). Specifically, the spectral measurement portions 2A and 2B each include a spectrometer that separates light having a desired wavelength from measurement target light reflected off the inspection target (or passing through inspection target), and a light receiver that receives the light separated by the spectrometer and outputs an optical signal according to the amount of received light. Note that a known spectral camera may be used as each of the spectral measurement portions 2A and 2B, and a spectral image may be acquired as the spectral information. Although not shown, the spectral measurement portions 2A and 2B may each include a light source that irradiates the inspection target with the measurement target light. The spectral measurement portions 2A and 2B may each be realized by the same instrument.

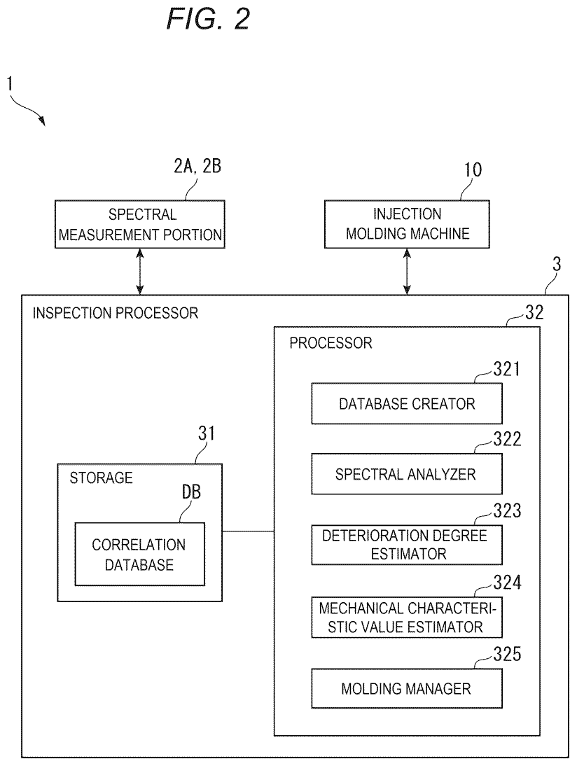

The inspection processer 3 controls the spectral measurement portions 2A and 2B to inspect the inspection target based on the spectral information acquired by the spectral measurement portions 2A and 2B. Specifically, the inspection processor 3 has a basic configuration of a typical computer such as a storage 31 configured with a memory or the like and a processor 32 configured with a CPU or the like, as shown in FIG. 2. The processor 32 functions as a database creator 321, a spectral analyzer 322, a deterioration degree estimator 323, a mechanical characteristic value estimator 324, and a molding manager 325 by reading and executing a program recorded in the storage 31.

The database creator 321 creates a correlation database DB and stores the correlation database DB in the storage 31. The correlation database DB in the present embodiment includes multiple pieces of correlation data. The multiple pieces of correlation data each include information such as a spectral characteristic value, the degree of deterioration of the recycled material, the content of the recycled material, and a mechanical characteristic value, which are associated with each other. It is preferable that the correlation database DB in the present embodiment contains multiple pieces of correlation data showing at least different degrees of deterioration, and contains correlation data corresponding to the virgin material.

Note that the database creator 321 may create the correlation database DB on an inspection target type basis. The database creator 321 may separately create correlation database DB corresponding to the resin materials and correlation database DB corresponding to the molded product W, or may create common correlation database DB corresponding to the resin materials and the molded product W.

The spectral analyzer 322 calculates an optical spectrum of the inspection target based on the spectral information acquired by the spectral measurement portions 2A and 2B. Note that the spectral analyzer 322 in the present embodiment calculates an absorbance spectrum as the optical spectrum.

The spectral analyzer 322 further calculates a spectral characteristic value at a light absorption wavelength based on the optical spectrum of the inspection target. Specifically, the spectral analyzer 322 in: present embodiment calculates a secondary differential spectrum by performing secondary differentiation on the optical spectrum, and calculates a secondary differential value at the light absorption wavelength as the spectral characteristic value. In the present embodiment, the secondary differential value serving as the spectral characteristic value is a value normalized by the secondary differential value of the optical spectrum of the virgin material.

Note that when the spectral information is a spectral image, any number of pixels out of the multiple pixels may be set as measurement points, and the average of spectral characteristic values determined from the multiple measurement points may be used as the spectral characteristic value.

The deterioration degree estimator 323 calculates the degree of deterioration of the recycled material contained in the inspection target based on the spectral characteristic value calculated by the spectral analyzer 322. Note in the present embodiment that the number by which the recycled material is recycled, that is, the number of times of the recycling is used as a parameter indicating the degree of deterioration. For example, the degree of deterioration corresponding to a case where the virgin material undergoes recycling once is referred to as “recycled once”, and the degree of deterioration corresponding to a case where the recycled-once recycled material undergoes recycling once more after molded is referred to as “recycled twice”.

The mechanical characteristic value estimator 324 calculates a mechanical characteristic value corresponding to the degree of deterioration of the recycled material contained in the inspection target at any resin content. Note that the mechanical characteristic value estimator 324 in the present embodiment calculates Charpy impact strength as the mechanical characteristic value.

The molding manager 325 calculates the recycled material content corresponding to each of the degree of deterioration of the recycled material contained in the inspection target and a target value of the mechanical characteristic of the inspection target, and outputs the calculated recycled material content to the injection molding machine 10.

### Relationship Between Degree of Deterioration and Amount of Light Absorption

The relationship between the degree of deterioration and the amount of light absorption in the present embodiment will be described.

In a typical resin material, light absorption occurs at a wavelength (light absorption wavelength) corresponding to the molecular vibration energy of a functional group. When the degree of deterioration of the resin material increases, the chemical structure of the functional group of the resin material is replaced with another structure, so that the amount of light absorption at the light absorption wavelength decreases.

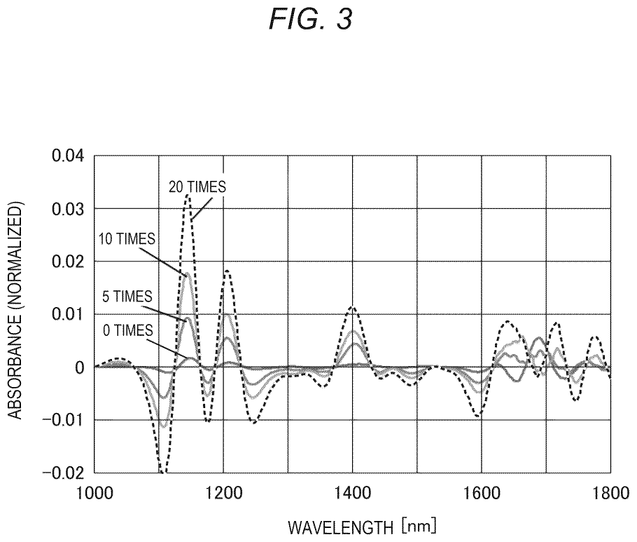

For example, FIG. 3 shows optical spectra (normalized secondary differential absorbance spectra) of multiple resin materials having different degrees of deterioration. Note in FIG. 3 that the resin material is ABS resin. FIG. 3 shows the optical spectrum of the virgin material and the optical spectra of the recycled materials the degrees of deterioration of which are 5, 10, and 20 times.

In the optical spectra shown in FIG. 3, peaks resulting from light absorption are observed at multiple light absorption wavelengths (for example, light absorption wavelengths in first sound region, second sound region, or combined sound region). In the optical spectra shown in FIG. 3, the height of the peak at each of the light absorption wavelengths increases as the degree of deterioration increases. This means that the amount of light absorption at a light absorption wavelength decreases as the degree of deterioration increases.

The aforementioned relationship between the degree of deterioration and the amount of light absorption can be similarly applied to a mixed resin material containing the recycled material and the virgin material at any proportions, and the molded product W molded from the mixed resin material. A conceivable reason for this is that in the mixed resin material and the molded product W made thereof, the virgin material and the recycled material are uniformly distributed with the structure of the functional group maintained, and light absorption according to each of the concentrations of the virgin material and the recycled material occurs.

Let Amix be the absorbance of the mixed resin material at a light absorption wavelength, Av be the absorbance of the virgin material at the light absorption wavelength, Ar be the absorbance of the recycled material at the light absorption wavelength, Cv be the content of the virgin material in the mixed material, and Cr be the content of the recycled material in the mixed material, and Expression (1) below is satisfied/

Amix=Av×Cv+Ar×Cr Expression (1)

The spectral characteristic value in the present embodiment is the quantified amount of light absorption at the light absorption wavelength. The spectral characteristic value in the present embodiment can therefore be applied to the absorbance expressed by Expression (1) above. Specifically, let Fmix be the spectral characteristic value of the mixed material at the light absorption wavelength, Fv be the spectral characteristic value of the virgin material at the light absorption wavelength, Fr be the spectral characteristic value of the recycled material at the light absorption wavelength, Cv be the content of the virgin material in the mixed material, and Cr be the content of the recycled material in the mixed material, Expression (2) below is satisfied.

Fmix=Fv×Cv+Fr×Cr Expression (2)

### Relationship Between Mechanical Characteristic Value and Amount of Light Absorption

The relationship between the mechanical characteristic value and the amount of light absorption in the present embodiment will be described.

In a typical resin material, the amount of light absorption at a light absorption wavelength has a strong correlation with not only the degree of deterioration but also the mechanical characteristic value. A conceivable reason for this is that the change in the chemical structure due to the deterioration of the resin material affects not only the amount of light absorption but also the mechanical characteristics.

The relationship between the mechanical characteristic value and the amount of light absorption in the present embodiment can be similarly applied to a mixed resin material containing the recycled material and the virgin material at any proportions, and the molded product W molded from the mixed resin material.

It can therefore be said that the mechanical characteristic value is proportional to each of the amount of light absorption (or spectral characteristic value), the degree of deterioration, and the content of the recycled material.

### Resin Inspection Method

A resin inspection method performed by the resin inspection apparatus 1 according to the present embodiment will be more specifically described.

The resin inspection method according to the present embodiment includes a preparation step of creating the correlation database DB, a first inspection step of inspecting the first resin material P1 to be loaded into the injection molding machine 10, and a second inspection step of inspecting the molded product W molded by the injection molding machine 10, as will be described below. Note that the first and second inspection steps can be performed independently of each other, and one of the steps may be omitted.

### Preparation Step

The database creator 321 creates the correlation database DB corresponding to the type of the inspection target (for example, type of resin, and state of inspection target). In this process, the database creator 321 creates the correlation database DB by acquiring correlation data on multiple samples (samples of first resin material P1 or molded product W) having at least different degrees of deterioration, and storing the correlation data in the storage 31. Note that the correlation data may be created by the resin inspection apparatus 1 or may be externally provided.

For example, when the resin inspection apparatus 1 creates correlation data, the spectral measurement portions 2A and 2B perform spectral measurement on the multiple samples having different degrees of deterioration, and the spectral analyzer 322 calculates spectral characteristic values based on the results of the spectral measurement performed on the samples. It is assumed that the degree of deterioration of the recycled material, the content of the recycled material, and the mechanical characteristic value related to each of the samples are known and externally input. The database creator 321 associates the spectral characteristic value calculated by the spectral analyzer 322 with the externally input known information to create correlation data, and stores the correlation data in the storage 31.

When the resin inspection apparatus 1 creates the correlation data, the spectral analyzer 322 may specify a light absorption wavelength based on the result of the spectral measurement performed on each of the samples. In this case, the spectral analyzer 322 can calculate the optical spectrum based on the result of the spectral measurement performed on each of the samples and specify any wavelength at which the calculated optical spectrum peaks as the light absorption wavelength. In this process, the spectral analyzer 322 may specify, as the light absorption wavelength, a wavelength at which a difference in secondary differential value between resin materials having different degrees of deterioration is greater than or equal to a predetermined value. For example, in the present embodiment, the light absorption wavelength is set at 1144 nm in the secondary differential absorbance spectrum shown in FIG. 3.

Note that information on the light absorption wavelength may be externally provided.

In the following description, the correlation database DB contains correlation data on a virgin material (recycled 0 times, recycled material content of 0%) and correlation data on each recycled material (recycled material content of 100%) having any degree of deterioration (for example, recycled 5 times, recycled 10 times, and recycled 20 times) for convenience of the description.

### First Inspection Step

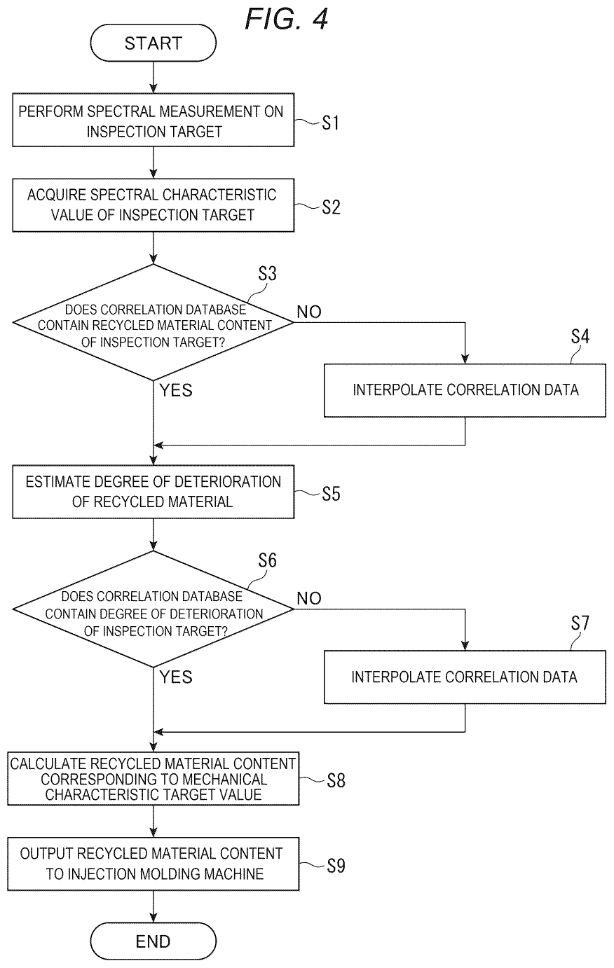

The first inspection step will be described with reference to the flowchart in FIG. 4. Note that the first inspection step is performed on the first resin material P1, which is loaded into the injection molding machine 10, as an inspection target as described above. Since the first resin material P1 in the present embodiment is a recycled material, it is known that the recycled material content of the first resin material P1 is 100%. The timing of the first inspection step may be any timing before the first resin material P1 is mixed with the second resin material P2.

First, the spectral measurement portion 2A performs spectral measurement on the inspection target (step S1), and the spectral analyzer 322 calculates the optical spectrum of the inspection target based on the result of the spectral measurement performed on the inspection target, and calculates a spectroscopic characteristic value at a light absorption wavelength based on the calculated optical spectrum (step S2).

The deterioration degree estimator 323 then refers to the correlation database DB and determines whether there is correlation data corresponding to the recycled material content (=100%) of the inspection target (step S3). In the present embodiment, since the correlation database DB contains correlation data on the recycled material (that is, recycled material content of 100%) (Yes in step S3), the deterioration degree estimator 323 estimates the degree of deterioration of the recycled material of the inspection target by using the correlation database DB as it is (step S5).

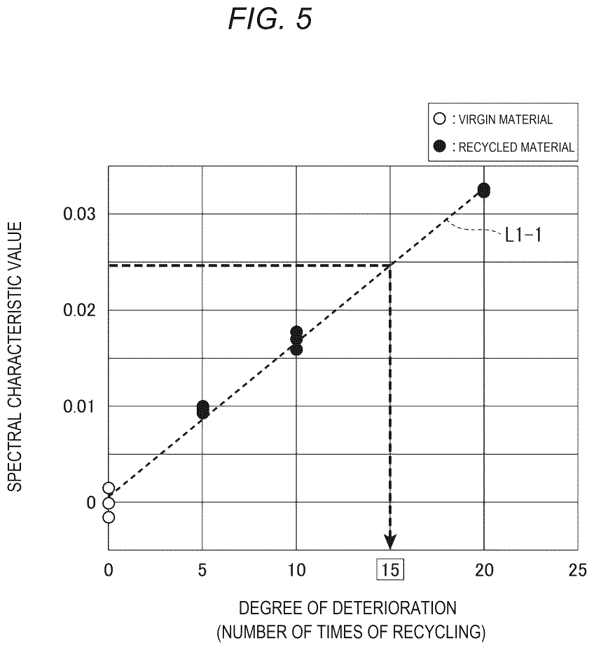

Specifically, the deterioration degree estimator 323 calculates, based on the correlation database DB, a first regression line L1-1 corresponding to the recycled material content (=100%) of the inspection target and representing the correlation between the spectral characteristic value and the degree of deterioration (see FIG. 5). Note that the first regression line L1-1 is desirably calculated by using linear approximation. The deterioration degree estimator 323 then calculates the degree of deterioration corresponding to the spectral characteristic value of the inspection target based on the first regression line L1-1. The spectral characteristic value of the inspection target is the value calculated in step S2. According to the first regression line L1-1 shown in FIG. 4 by way of example, the degree of deterioration corresponding to the spectral characteristic value (=0.248) of the inspection target is calculated to be recycled 15 times. The deterioration degree estimator 323 can therefore estimate the degree of deterioration of the recycled material in the inspection target as recycled 15 times.

The mechanical characteristic value estimator 324 then refers to the correlation database DB and determines whether there is correlation data corresponding to the degree of deterioration (=recycled 15 times) of the recycled material of the inspection target (step S6). In the present embodiment, since the correlation database DB does not contain the correlation data showing recycled 15 times (No in step S6), the mechanical characteristic value estimator 324 estimates a mechanical characteristic value corresponding to the degree of deterioration (=recycled 15 times) of the recycled material of the inspection target (when recycled material content is 100%), and interpolates the correlation data corresponding to the degree of deterioration of the inspection target into the correlation database DB (step S7).

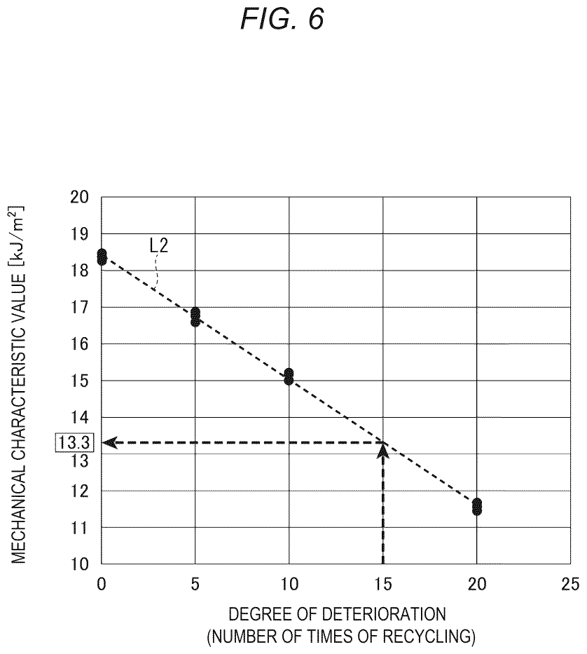

Specifically, the mechanical characteristic value estimator 324 calculates, based on the correlation database DB, a second regression line L2 corresponding to the recycled material content of 100% and representing the correlation between the degree of deterioration and the mechanical characteristic value (see FIG. 6). Note that the second regression line L2 is desirably calculated by using linear approximation. The mechanical characteristic value estimator 324 then calculates a mechanical characteristic value corresponding to the degree of deterioration of the recycled material in the inspection target based on the second regression line L2. The degree of deterioration of the recycled material in the inspection target is the value calculated in step S5. According to the second regression line L2 shown in FIG. 5 by way of example, the mechanical characteristic value corresponding to the degree of deterioration (recycled 15 times) of the recycled material in the inspection target is calculated to be 13.3 kJ/m². The mechanical characteristic value estimator 324 can therefore estimate the mechanical characteristic value corresponding to the degree of deterioration (=recycled 15 times) of the recycled material of the inspection target (when recycled material content is 100%) to be 13.3 kJ/m². The mechanical characteristic value estimator 324 then stores the correlation data estimated or set in relation to the inspection target (spectral characteristic value: 0.248, degree of deterioration: recycled 15 times, mechanical characteristic value: 13.3 kJ/m², recycled material content: 100%) in the storage 31, and can interpolate the correlation database DB.

The molding manager 325 then calculates the recycled material content corresponding to a target value of the mechanical characteristic (step S8). The target value of the mechanical characteristic is not limited to a specific value, and is, for example, an externally input value.

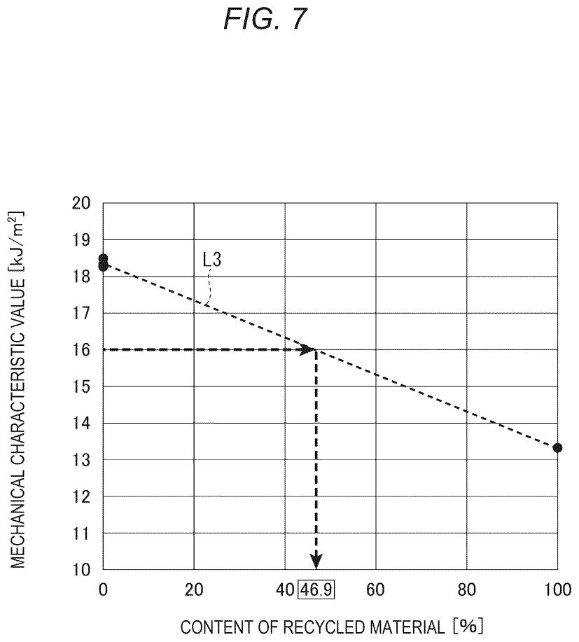

Specifically, the molding manager 325 calculates a third regression line L3 corresponding to the degree of deterioration of the recycled material in the inspection target and representing the correlation between the recycled material content and the mechanical characteristic value based on the correlation database DB (see FIG. 7). In this process, correlation data usable in the correlation database DB to calculate the third regression line L3 are correlation data interpolated in step S7 and corresponding to the degree of deterioration of the inspection target (recycled material content 100%, mechanical characteristic value 13.3 kJ/m²) and correlation data on the virgin material contained in advance in the correlation database DB (recycled material content 0%, mechanical characteristic value 18.4 kJ/m²). Note that the third regression line L3 is desirably calculated by using linear approximation. The molding manager 325 then calculates the recycled material content corresponding to the target value of the mechanical characteristic based on the third regression line L3. According to the third regression line L3 shown in FIG. 7 by way of example, the recycled material content corresponding to the target value of the mechanical characteristic (for example, 16.0 kJ/m²) can be calculated to be 46.9%.

The molding manager 325 finally outputs the recycled material content (=46.9%) calculated in step S8 to the injection controller 14 of the injection molding machine 10 (step S9). The injection controller 14 can control the resin loader 11 based on the input recycled material content to adjust the proportion of the first resin material P1 in the mixed resin material P3 (that is, content of recycled material in molded product W). The injection molding machine 10 can thus mold a molded product W having a desired mechanical characteristic value.

### Second Inspection Step

The second inspection step will be described with reference to the flowchart in FIG. 4 again. Note that the second inspection step is performed on the molded product W molded by the injection molding machine 10, as described above. The timing of the second inspection step is not limited to a specific timing, and may be any timing after the injection molding machine 10 starts molding the molded product W. For example, each molded product W continuously molded by the injection molding machine 10 may be inspected as the inspection target. Note that the content of the recycled material in the molded product W under inspection is known (for example, 30%).

First, the spectral measurement portion 2B performs spectral measurement on the inspection target (step S1), and the spectral analyzer 322 calculates the optical spectrum of the inspection target based on the result of the spectral measurement performed on the inspection target, and calculates a spectroscopic characteristic value at a light absorption wavelength based on the calculated optical spectrum (step S2).

The deterioration degree estimator 323 then refers to the correlation database DB and determines whether there is correlation data corresponding to the recycled material content (=30%) of the inspection target (step S3). In the present embodiment, since there is no correlation data corresponding to the recycled material content of 30% in the correlation database DB (No in step S3), the deterioration degree estimator 323 interpolates correlation data corresponding to the recycled material content of 30% into the correlation database DB (step S4).

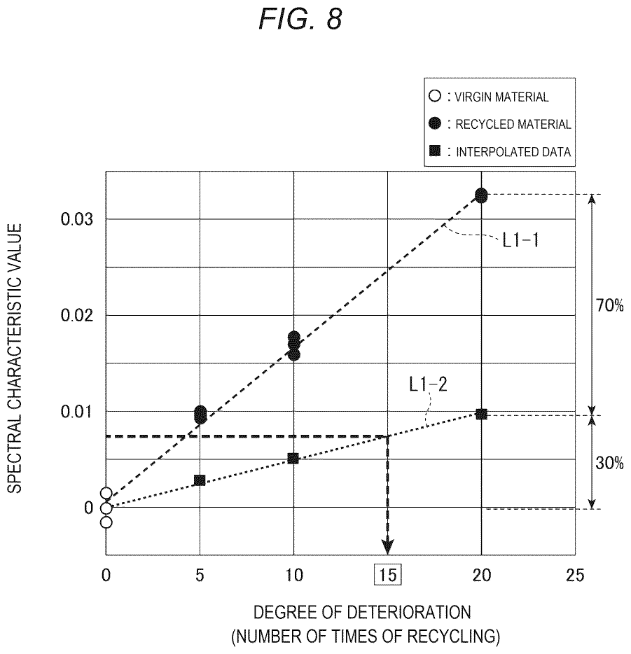

Specifically, the deterioration degree estimator 323 calculates the correlation data corresponding to the recycled material content of 30% based on correlation data already contained in the correlation database DB by using the expression of the correlation between the spectral characteristic value and the recycled material content (see Expression (2) described above). For example, the deterioration degree estimator 323 can calculate the spectral characteristic value Fmix corresponding to any degree of deterioration (for example, recycled 5 times, 10 times, or 20 times) and recycled material content of 30% by using Expression (3) below (see FIG. 8). In Expression (3), Fv represents the spectral characteristic value of the virgin material, and Fr represents the spectral characteristic value of the recycled material the degree of deterioration of which is the same as that in the correlation data to be created (recycled 5 times, 10 times, or 20 times).

Fmix=Fv×(70/100)+Fr×(30/100) Expression (3)

The deterioration degree estimator 323 then stores the spectral characteristic value Fmix calculated by Expression (3) described above in the storage 31 as correlation data together with corresponding data.

Note that the spectral characteristic value Fr, based on which the correlation data is created, may be a value in the correlation database DB as it is, or may be a value calculated from the first regression line L1-1 described above.

If there is correlation data corresponding to the content of the recycled material (=30%) of the inspection target in the correlation database DB (Yes in S3), step S4 may be omitted as in the first inspection step.

The deterioration degree estimator 323 then estimates the degree of deterioration of the recycled material of the inspection target based on the interpolated correlation database DB (step S5).

Specifically, the deterioration degree estimator 323 calculates, based on the interpolated correlation database DB, a first regression line L1-2 corresponding to the recycled material content (=30%) of the inspection target and representing the correlation between the spectral characteristic value and the degree of deterioration (see FIG. 8). Note that the first regression line L1-2 is desirably calculated by using linear approximation. The deterioration degree estimator 323 then calculates the degree of deterioration corresponding to the spectral characteristic value of the inspection target based on the first regression line L1-2. The spectral characteristic value of the inspection target is the value calculated in step S2. According to the first regression line L1-2 shown in FIG. 8 by way of example, the degree of deterioration corresponding to the spectral characteristic value (=0.007) of the inspection target is calculated to be recycled 15 times. The deterioration degree estimator 323 can therefore estimate the degree of deterioration of the recycled material in the inspection target as recycled 15 times.

The mechanical characteristic value estimator 324 then refers to the correlation database DB and determines whether there is correlation data corresponding to the degree of deterioration (=recycled 15 times) of the recycled material of the inspection target (step S6).

When the correlation database DB does not contain the correlation data showing recycled 15 times (No in step S6), the mechanical characteristic value estimator 324 estimates a mechanical characteristic value corresponding to the degree of deterioration (=recycled 15 times) of the recycled material of the inspection target (when recycled material content is 100%), and interpolates the correlation data corresponding to the degree of deterioration of the inspection target into the correlation database DB (step S7), as in the first inspection step described above. Note that a specific method for carrying out step S7 will not be described because the description in the first inspection step can be referred to.

When there is correlation data corresponding to the degree of deterioration (=recycled 15 times) in the correlation database DB (Yes in step S6), step S7 is not carried out, and the process proceeds to the next step S8.

The molding manager 325 then calculates the recycled material content corresponding to a target value of the mechanical characteristic (step S8). Note that a specific method for carrying out step S8 will not be described because the description in the first inspection step can be referred to.

The molding manager 325 finally outputs the recycled material content calculated in step S8 to the injection controller 14 of the injection molding machine 10 (step S9). The injection controller 14 can control the resin loader 11 based on the input recycled material content to adjust the proportion of the first resin material P1 in the mixed resin material P3 (that is, content of recycled material in molded product W). The injection molding machine 10 can thus mold a molded product W having a desired mechanical characteristic value.

### Advantages of Present Embodiment

(1) In the resin inspection apparatus 1 according to the present embodiment, the processor 32 of the inspection processor 3 reads and executes the program stored in the storage 31 to perform the resin inspection method according to the present embodiment. The resin inspection method according to the present embodiment is a method for inspecting the first resin material P1 containing a recycled material or the molded product W made of the mixed resin material P3 as an inspection target, the method including: a spectral characteristic value calculation step (step S2) acquiring of a spectral characteristic value at a light absorption wavelength of the inspection target; and a deterioration degree estimation step (step S5) of estimating the degree of deterioration of the recycled material in the inspection target based on the spectral characteristic value of the inspection target, the deterioration degree estimation step including calculating first regression lines L1-1 and L1-2 corresponding to the recycled material content of the inspection target and representing the correlation between the spectral characteristic value and the degree of deterioration based on the correlation database DB containing multiple pieces of correlation data in each of which the spectral characteristic value, the degree of deterioration of the recycled material, and the recycled material content in the resin material are associated with each other and in which at least the degrees of deterioration differ from each other, and calculating the degree of deterioration corresponding to the spectral characteristic value of the inspection target based on the first regression lines L1-1 and L1-2.

The resin inspection apparatus 1 or the resin inspection method according to the present embodiment can therefore accurately determine the degree of deterioration of the recycled material in the inspection target even when the inspection target contains the recycled material the content of which varies.

(2) In the spectral characteristic value calculation step in the present embodiment, the optical spectrum of the inspection target is calculated based on the result of spectral measurement performed on the inspection target at multiple wavelengths, and the spectral characteristic value at the light absorption wavelength of the inspection target is calculated based on the optical spectrum.

In the method described above, the spectral characteristic value of the inspection target can be readily determined without imposing a load on the inspection target.

(3) In the spectral characteristic value calculation step in the present embodiment, the spectral characteristic value is calculated based on the spectral spectrum or a differential spectrum that is the spectral spectrum differentiated once or more times.

In the method described above, since a change resulting from the deterioration of the recycled material is suitably reflected in the spectral characteristic value, the degree of deterioration of the recycled material can be accurately determined from the spectral characteristic value.

(4) In the spectral characteristic value calculation step in the present embodiment, the light absorption wavelength of the inspection target is identified based on the optical spectrum or a differential spectrum that is the spectral spectrum differentiated once or more times.

In the method described above, since the light absorption wavelength suitable for each inspection target can be identified, the degree of deterioration of the recycle material can be accurately determined from the spectral characteristic value corresponding to the light absorption wavelength.

(5) The resin inspection method according to the present embodiment further includes a first interpolation step (step S4) of interpolating, into the correlation database DB, correlation data corresponding to the recycled material content of the inspection target based on an expression of the correlation between the spectral characteristic value and the recycled material content, before the deterioration degree estimation step.

In the method described above, even when the correlation database DB does not contain in advance the recycled material content of the inspection target, the first regression line L1-2 corresponding to the recycled material content of the inspection target can be determined. Therefore, even when the inspection target contains the recycled material the content of which varies, the degree of deterioration of the recycled material in the inspection target can be accurately determined.

(6) The correlation database DB in the present embodiment contains multiple pieces of correlation data in each of which the spectral characteristic value, the degree of deterioration, the recycled material content, and the mechanical characteristic value of the resin material are associated with each other and in which at least the degrees of deterioration differ from each other, and the resin inspection method according to the present embodiment further includes a recycled material content calculation step (step S8) of calculating a third regression line L3 corresponding to the degree of deterioration of the recycled material in the inspection target and representing the correlation between the recycled material content and the mechanical characteristic value based on the correlation database DB, and calculating the recycled material content corresponding to a target value of the mechanical characteristic based on the third regression line L3, and an output step (step S9) of outputting the recycled material content calculated in the recycled material content calculation step to the injection molding machine 10.

In the method described above, when the recycled material having the estimated degree of deterioration is used, a recycled material content that realizes a desired mechanical characteristic value can be determined. Furthermore, outputting the determined recycled material content to the injection molding machine 10 allows the injection molding machine 10 to manufacture a molded product W having a desired mechanical characteristic value.

(7) The resin inspection method according to the present embodiment further includes a mechanical characteristic value calculation step of calculating a second regression line L2 representing the correlation between the degree of deterioration and the mechanical characteristic value based on the correlation database DB, and calculating the mechanical characteristic value corresponding to the degree of deterioration of the inspection target based on the second regression line L2, and a second interpolation step (step S7) of interpolating, into the correlation database, correlation data corresponding to the degree of deterioration of the inspection target and containing the mechanical characteristic value calculated in the mechanical characteristic value calculation step, before the recycled material content calculation step.

In the method described above, even when the correlation database DB does not contain in advance the degree of deterioration of the inspection target, the second regression line L2 corresponding to the degree of deterioration of the inspection target can be determined. Therefore, even when the inspection target deteriorates by various degrees, the recycled material content calculation step described above can be accurately performed by interpolating the correlation data corresponding to the degree of deterioration of the recycled material of the inspection target.

(8) In addition to the above, in the present embodiment, the recycled material contained in the resin material or the molded product can be inspected by a non-destructive, noncontact, and simple approach. The mechanical characteristics having been measured in sampling inspection in related art can therefore be inspected in a full inspection. Furthermore, since high-level management can be conducted on the quality of the molded product W, stable quality of a recycled product, which shows large variation in quality in related art, can be realized. Moreover, since the full inspection can be performed, the amount of the recycled material to be used can be increased while a standard required for the product is satisfied.

### VARIATIONS

The present disclosure is not limited to the embodiment described above, and variations, improvements, and other changes to the extent that the advantages of the present disclosure are achieved fall within the scope of the present disclosure.

### Variation 1

In the second inspection step in the embodiment described above, the recycled material content corresponding to the target value of the mechanical characteristic is output to the injection molding machine 10 to manage the mechanical characteristic of the molded product W, but the mechanical characteristic of the molded product W may be managed by another approach.

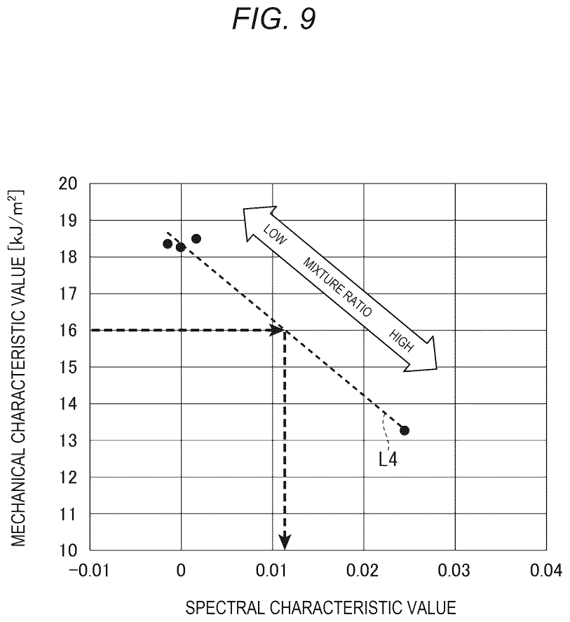

Specifically, in the second inspection step in the embodiment described above, steps S8 and S9 may be omitted. In this case, after step S7, the molding manager 325 performs an increase/decrease determination step of determining an increase/decrease in the content of the recycled material based on the spectral characteristic value of the inspection target, and an output step of outputting an increase/decrease instruction determined in the increase/decrease determination step to the injection molding machine 10. The increase/decrease determination step includes calculating a fourth regression line L4 (see FIG. 9) corresponding to the degree of deterioration of the inspection target and representing the correlation between the spectral characteristic value and the mechanical characteristic value based on the correlation database, and comparing a spectral characteristic value F1 corresponding to the target value of the mechanical characteristic on the fourth regression line L4 with a spectral characteristic value F2 of the inspection target and determining an increase/decrease in the recycled material content based on the result of the comparison. Note that the fourth regression line L4 is desirably calculated by using linear approximation.

A data point on the fourth regression line L4 shown in FIG. 9 by way of example moves rightward as the recycled material content increases, and moves leftward as the recycled material content decreases. Therefore, when “the spectral characteristic value F1 corresponding to the target value of the mechanical characteristic”< “the spectral characteristic value F2 of the inspection target” is satisfied, the molding manager 325 determines that the recycled material content is decreased. When “the spectral characteristic value F1 corresponding to the target value of the mechanical characteristic”> “the spectral characteristic value F2 of the inspection target” is satisfied, the molding manager 325 determines that the recycled material content is increased. Note that when “the spectral characteristic value F1 corresponding to the target value of the mechanical characteristic”=“the spectral characteristic value F2 of the inspection target” is satisfied, the molding manager 325 may determine that the recycled material content is maintained at the current value. The amount of decrease or increase may, for example, be an amount specified in advance.

If the target value of the mechanical characteristic is 16.0 kJ/m², the spectral characteristic value corresponding to the mechanical characteristic target value of 16.0 kJ/m² is 0.011 in accordance with the fourth regression line L4 shown in FIG. 9 by way of example. Therefore, when the spectral characteristic value of the inspection target is greater than 16.0 kJ/m², the molding manager 325 determines that the recycled material content is decreased so that the data point on the fourth regression line L4 moves leftward. When the spectral characteristic value of the inspection target is smaller than 16.0 kJ/m², the molding manager 325 determines that the recycled material content is decreased so that the data point on the fourth regression line L4 moves rightward.

### Variation 2

In the embodiment described above, the mechanical characteristic value is estimated as one step in the second interpolation step (step S7), but not necessarily in the present disclosure. That is, in the resin inspection apparatus 1 according to the present embodiment, the mechanical characteristic value may be estimated as appropriate separately from the first inspection step or the second inspection step. Specifically, the mechanical characteristic value estimator 324 may perform as appropriate the mechanical characteristic value calculation step of calculating the second regression line L2 representing the correlation between the degree of deterioration and the mechanical characteristic value based on the correlation database DB, and calculating the mechanical characteristic value corresponding to the degree of deterioration of the recycled material in the inspection target based on the second regression line L2.

### Variation 3

In the embodiment described above, the correlation data on the virgin material (recycled 0 times, recycled material content of 0%) and the correlation data on the recycled material having any degree of deterioration (recycled 1 or more times, recycled material content of 100%) are presented by way of example as the correlation data contained in the correlation database DB, but not necessarily in the present disclosure. That is, the correlation database DB may contain multiple pieces of correlation data showing at least different degrees of deterioration, and the correlation data may each be interpolated as necessary.

In the embodiment described above, the correlation data each contains the spectral characteristic value, the degree of deterioration, the recycled material content, and the mechanical characteristic value, but not necessarily in the present disclosure. For example, when the mechanical characteristic is not estimated, the mechanical characteristic value in each of the correlation data may be omitted.

### Variation 4

The spectral analyzer 322 in the embodiment described above performs secondary differentiation on the optical spectrum and calculates a value corresponding to the light absorption wavelength of the secondary differential spectrum as the spectral characteristic value, but not necessarily in the present disclosure. That is, the spectral characteristic value only needs to be the quantified amount of light absorption at the light absorption wavelength, and the spectral analyzer 322 may calculate a value corresponding to the light absorption wavelength as the spectral characteristic value based on the optical spectrum or a differential spectrum that is the spectral spectrum differentiated once or more times. The spectral analyzer 322 may identify the light absorption wavelength based on the optical spectrum or a differential spectrum that is the spectral spectrum differentiated once or more times. The spectral characteristic value may not be normalized by a differential value of the optical spectrum of the virgin material.

### Variation 5

The optical spectrum in the embodiment described above is an absorbance spectrum, but not necessarily in the present disclosure, and may be a transmittance spectrum or a reflectance spectrum.

### Variation 6

In the embodiment described above, Charpy impact strength is used as the mechanical characteristic value of the resin material, but not necessarily in the present disclosure. For example, the mechanical characteristic value of the resin material may be any strength characteristic value such as tensile strength, bending strength, or impact strength, or may be any flow characteristic value such as complex viscosity, storage modulus of elasticity, loss modulus of elasticity, melt flow rate (MCR), or melt volume rate (MVR).

### Variation 7

The resin inspection apparatus 1 according to the embodiment described above includes the spectral measurement portions 2A and 2B, which perform spectral measurement on the inspection target, but not necessarily in the present disclosure. For example, the resin inspection apparatus 1 may acquire the spectral characteristic value of the inspection target by receiving the result of the spectral measurement (such as optical spectrum or spectral characteristic value) performed on the inspection target measured by another measurement apparatus.

### Variation 8

The regression lines described in the above embodiment described and Variation 1 are each a linear function calculated by using linear approximation, but not necessarily in the present disclosure. The regression line may, for example, be a high-order equation, an exponential function expression, a logarithmic function expression, or any other regression line that monotonically increases or decreases.

### Variation 9

In the embodiment described above, a resin material that is the inspection target is the first resin material P1, and the first resin material P1 is a recycled material (that is, recycled material content is 100%), but not necessarily in the present disclosure. For example, in the embodiment described above, a resin material having any recycled material content may be used as the inspection target. In other words, a resin material that is the inspection target only needs to contain the recycled material the content of which is greater than 0% but smaller than or equal to 100% of the resin material.

### Variation 10

In the embodiment described above, the number of times of recycling is used as the degree of deterioration of the recycled material, but is not limited to the number of times of recycling that the recycled material has actually undergone. For example, the recycled material in the embodiment described above may be a mixed recycled material that is a mixture of multiple recycled materials having undergone the recycling different times (for example, recycled material having been recycled once and recycled material having been recycled twice). Such a mixed recycled material has a degree of deterioration according to the proportions of the multiple recycled materials mixed with one another.

As the degree of deterioration of the recycled material, an indicator other than the number of times of recycling may be used. For example, as the degree of deterioration of the recycled material, a parameter related to a thermal load (specifically, load temperature, load period, or the like) or a parameter related to optical deterioration due to ultraviolet rays or the like (specifically, irradiation power, wavelength, irradiation period, or the like) may be used.

### Variation 11

The resin inspection method and the resin inspection apparatus 1 according to the embodiment described above are used with the injection molding machine 10, but not necessarily in the present disclosure, and may be used with a resin molding machine other than the injection molding machine 10. A resin material that is the inspection target does not necessarily have a pellet shape, and may have any granular shape or may be a fluid.

### Summary of Present Disclosure

A resin inspection method according to a first aspect of the present disclosure is a resin inspection method for inspecting a resin material containing a recycled material or a molded product made of the resin material as an inspection target, the method including: a spectral characteristic value calculation step of acquiring a spectral characteristic value at a light absorption wavelength of the inspection target; and a deterioration degree estimation step of estimating a degree of deterioration of the recycled material contained in the inspection target based on the spectral characteristic value of the inspection target, the deterioration degree estimation step including calculating a first regression line corresponding to a content of the recycled material of the inspection target and representing a correlation between the spectral characteristic value and the degree of deterioration based on a correlation database containing multiple pieces of correlation data in each of which the spectral characteristic value, the degree of deterioration of the recycled material, and the content of the recycled material in the resin material are associated with each other and in which at least the degrees of deterioration differ from each other, and calculating the degree of deterioration corresponding to the spectral characteristic value of the inspection target based on the first regression line.

In the spectral characteristic value calculation step in the present aspect, an optical spectrum of the inspection target is calculated based on a result of spectral measurement performed on the inspection target at multiple wavelengths, and the spectral characteristic value at the light absorption wavelength of the inspection target is calculated based on the optical spectrum.

In the spectral characteristic value calculation step in the present aspect, the spectral characteristic value may be calculated based on the spectral spectrum or a differential spectrum that is the spectral spectrum differentiated once or more times.

The spectral characteristic value calculation step in the present aspect may include identifying the light absorption wavelength of the inspection target based on the spectral spectrum or a differential spectrum that is the spectral spectrum differentiated once or more times.

The resin inspection method according to the present aspect may further include a first interpolation step of interpolating the correlation data corresponding to the content of the recycled material of the inspection target into the correlation database based on an expression of the correlation between the spectral characteristic value and the content of the recycled material before the deterioration degree estimation step.

The correlation database in the present aspect may include multiple pieces of the correlation data in which the spectral characteristic value, the degree of deterioration, the content of the recycled material, and a mechanical characteristic value of the resin material are associated with each other and at least the degrees of deterioration differ from each other, and the resin inspection method according to the present aspect may further include a mechanical characteristic value calculation step of calculating a second regression line representing a correlation between the degree of deterioration and the mechanical characteristic value based on the correlation database, and calculating the mechanical characteristic value corresponding to the degree of deterioration of the recycled material in the inspection target based on the second regression line.

It is preferable that the correlation database in the present aspect contains multiple pieces of the correlation data in each of which the spectral characteristic value, the degree of deterioration, the content of the recycled material, and the mechanical characteristic value of the resin material are associated with each other and in which at least the degrees of deterioration differ from each other, and the resin inspection method according to the present aspect further includes a recycled material content calculation step of calculating a third regression line corresponding to the degree of deterioration of the recycled material in the inspection target and representing a correlation between the content of the recycled material and the mechanical characteristic value based on the correlation database, and calculating the content of the recycled material corresponding to a target value of a mechanical characteristic based on the third regression line, and an output step of outputting the content of the recycled material calculated in the recycled material content calculation step to a molding machine configured to mold the molded product from the resin material.

The resin inspection method according to the present aspect may further include a mechanical characteristic value calculation step of calculating a second regression line representing a correlation between the degree of deterioration and the mechanical characteristic value based on the correlation database, and calculating the mechanical characteristic value corresponding to the degree of deterioration of the inspection target based on the second regression line, and a second interpolation step of interpolating, into the correlation database, the correlation data corresponding to the degree of deterioration of the inspection target and containing the mechanical characteristic value calculated in the mechanical characteristic value calculation step, before the recycled material content calculation step.

The correlation database in the present aspect may include multiple pieces of the correlation data in each of which the spectral characteristic value, the degree of deterioration, the content of the recycled material, and a mechanical characteristic value of the resin material are associated with each other and in which at least the degrees of deterioration differ from each other, and the resin inspection method according to the present aspect may further include: an increase/decrease determination step of determining an increase/decrease in the content of the recycled material based on the spectral characteristic value of the inspection target; and an output step of outputting an increase/decrease instruction determined in the increase/decrease determination step to a molding machine configured to mold the molded product from the resin material, the increase/decrease determination step may include calculating, based on the correlation database, a fourth regression line corresponding to the degree of deterioration of the inspection target and representing a correlation between the spectral characteristic value and the mechanical characteristic value, comparing the spectral characteristic value corresponding to a target value of a mechanical characteristic in the fourth regression line with the spectral characteristic value of the inspection target, and determining an increase or decrease in the content of the recycled material based on a result of the comparison.

A resin inspection apparatus according to a second aspect of the present disclosure is a resin inspection apparatus configured to inspect a resin material containing a recycled material or a molded product made of the resin material as an inspection target, the resin inspection apparatus including: a spectral analyzer configured to acquire a spectral characteristic value at a light absorption wavelength of the inspection target; a storage configured to store a correlation database containing multiple pieces of correlation data in each of which the spectral characteristic value, a degree of deterioration of the recycled material, and a content of the recycled material of the resin material are associated with each other and in which at least the degrees of deterioration differ from each other; and a deterioration degree estimator configured to calculate a first regression line corresponding to the content of the recycled material of the inspection target and representing between a correlation the spectral characteristic value and the degree of deterioration based on the correlation database, and calculate the degree of deterioration corresponding to the spectral characteristic value of the inspection target based on the first regression line.

What is claimed is:

1. A resin inspection method for inspecting a resin material containing a recycled material or a molded product made of the resin material as an inspection target, the method comprising:
acquiring a spectral characteristic value at a light absorption wavelength of the inspection target; and
estimating a degree of deterioration of the recycled material contained in the inspection target based on the spectral characteristic value of the inspection target,
wherein estimating the degree of deterioration includes:
calculating a first regression line corresponding to a content of the recycled material of the inspection target and representing a correlation between the spectral characteristic value and the degree of deterioration based on a correlation database containing multiple pieces of correlation data in each of which the spectral characteristic value, the degree of deterioration of the recycled material, and the content of the recycled material in the resin material are associated with each other and in which at least the degrees of deterioration differ from each other, and
calculating the degree of deterioration corresponding to the spectral characteristic value of the inspection target based on the first regression line.

2. The resin inspection method according to claim 1,
wherein acquiring the spectral characteristic value includes:
calculating an optical spectrum of the inspection target based on a result of spectral measurement performed on the inspection target at multiple wavelengths, and
calculating the spectral characteristic value at the light absorption wavelength of the inspection target based on the optical spectrum.

3. The resin inspection method according to claim 2,
wherein calculating the spectral characteristic value includes calculating the spectral characteristic value based on the spectral spectrum or a differential spectrum that is the spectral spectrum differentiated once or more times.

4. The resin inspection method according to claim 2,
wherein acquiring the spectral characteristic value includes identifying the light absorption wavelength of the inspection target based on the spectral spectrum or a differential spectrum that is the spectral spectrum differentiated once or more times.

5. The resin inspection method according to claim 1 further comprising
interpolating the correlation data corresponding to the content of the recycled material of the inspection target into the correlation database based on an expression of a correlation between the spectral characteristic value and the content of the recycled material before estimating the degree of deterioration.

6. The resin inspection method according to claim 1,
wherein the correlation database includes multiple pieces of the correlation data in which the spectral characteristic value, the degree of deterioration, the content of the recycled material, and a mechanical characteristic value of the resin material are associated with each other and at least the degrees of deterioration differ from each other, and
the resin inspection method further comprises:
calculating a second regression line representing correlation between the degree of deterioration and the mechanical characteristic value based on the correlation database, and
calculating the mechanical characteristic value corresponding to the degree of deterioration of the recycled material in the inspection target based on the second regression line.

7. The resin inspection method according to claim 1,
wherein the correlation database contains multiple pieces of the correlation data in each of which the spectral characteristic value, the degree of deterioration, the content of the recycled material, and a mechanical characteristic value of the resin material are associated with each other and in which at least the degrees of deterioration differ from each other, and
the resin inspection method further comprises:
calculating a third regression line corresponding to the degree of deterioration of the recycled material in the inspection target and representing a correlation between the content of the recycled material and the mechanical characteristic value based on the correlation database, and calculating the content of the recycled material corresponding to a target value of a mechanical characteristic based on the third regression line; and
outputting the content of the recycled material to a molding machine configured to mold the molded product from the resin material.

8. The resin inspection method according to claim 7 further comprising:
calculating a second regression line representing a correlation between the degree of deterioration and the mechanical characteristic value based on the correlation database, and calculating the mechanical characteristic value corresponding to the degree of deterioration of the inspection target based on the second regression line, and
interpolating, into the correlation database, the correlation data corresponding to the degree of deterioration of the inspection target and containing the mechanical characteristic value before calculating the third regression line.

9. The resin inspection method according to claim 1,
wherein the correlation database includes multiple pieces of the correlation data in each of which the spectral characteristic value, the degree of deterioration, the content of the recycled material, and a mechanical characteristic value of the resin material are associated with each other and in which at least the degrees of deterioration differ from each other, and
the resin inspection method further includes:
determining an increase/decrease in the content of the recycled material based on the spectral characteristic value of the inspection target; and
outputting an increase/decrease instruction to a molding machine configured to mold the molded product from the resin material,
wherein determining the increase/decrease includes
calculating, based on the correlation database, a fourth regression line corresponding to the degree of deterioration of the inspection target and representing a correlation between the spectral characteristic value and the mechanical characteristic value,
comparing the spectral characteristic value corresponding to a target value of a mechanical characteristic in the fourth regression line with the spectral characteristic value of the inspection target, and
determining an increase or decrease in the content of the recycled material based on a result of the comparison.

10. A resin inspection apparatus configured to inspect a resin material containing a recycled material or a molded product made of the resin material as an inspection target, the resin inspection apparatus comprising:
a spectral analyzer configured to acquire a spectral characteristic value at a light absorption wavelength of the inspection target;
a storage configured to store a correlation database containing multiple pieces of correlation data in each of which the spectral characteristic value, a degree of deterioration of the recycled material, and a content of the recycled material of the resin material are associated with each other and in which at least the degrees of deterioration differ from each other; and
a deterioration degree estimator configured to calculate a first regression line corresponding to the content of the recycled material of the inspection target and representing a correlation between the spectral characteristic value and the degree of deterioration based on the correlation database, and calculate the degree of deterioration corresponding to the spectral characteristic value of the inspection target based on the first regression line.
